(19) United States
(12) Patent Application Publication
(10) Pub. No.: US 2023/0166273 A1
(43) Pub. Date: Jun. 1, 2023

(54) FULL CIRCUMFERENCE SPRAY NOZZLE INSERT, ASSEMBLY, AND METHOD

(71) Applicant: dlhBOWLES, Inc., Canton, OH (US)

(72) Inventors: Evan Hartranft, Bowie, MD (US); Chunling Zhao, Ellicott City, MD (US); Sridhar Gopalan, Westminster, MD (US); Gregory A. Russell, Catonsville, MD (US); Reza Ronghian, Rockville, MD (US)

(21) Appl. No.: 18/073,006

(22) Filed: Dec. 1, 2022

Related U.S. Application Data
(60) Provisional application No. 63/284,889, filed on Dec. 1, 2021.

(51) Int. Cl. B05B 1/08; B08B 3/02

(52) U.S. Cl. CPC B05B 1/08; B08B 3/024

(57) ABSTRACT

A fluidic oscillator insert is designed to project a full circumference spray pattern from a single outlet that is characterized by slightly convex or outwardly curving radius and a combination of full and partial protrusions immediately in front of the outlet, in combination with curved walls defining the throat of the outlet (and even outer surfaces of the housing), surprisingly produces full circumference, oscillating spray pattern. Further aspects of the invention include a system and a double exit insert, both of which also produce full circumference oscillating spray patterns.

### CROSS REFERENCE TO RELATED APPLICATIONS

This application claims priority to U.S. provisional patent application Ser. No. 63/284,889, filed on Dec. 1, 2021, which is incorporated by reference herein.

### TECHNICAL FIELD

The disclosure relates to a nozzle assembly having a fluidic oscillating insert geometry capable of generating a 360 degree spray fan about the nozzle housing.

### BACKGROUND

With the continued proliferation of cameras, optical sensors, and other modern-day conveniences requiring periodic wetting and/or cleaning, a wide variety of spray nozzles are needed. Ideally, these sprayers will have no moving parts, while retaining a compact size and delivering a well-defined and repeatable spray pattern.

Fluidic oscillators represent a specialized class of sprayers/nozzles that meet many of these needs. Fluidic oscillators employ specialized flow chambers and channels in which various fluid flow phenomena are combined to produce spray patterns. U.S. Pat. Nos. 4,662,568; 8,172,162; and 11,305,297, as well as United States Patent Publication 2010/0090036 (all of which are incorporated by reference), provide excellent but non-limiting examples of the possibilities for fluidic oscillators. Because of their comparatively small size, these fluidic oscillators can be manufactured into inserts or “chips” that sealingly fitted into housing and/or other components in the flowpath of spaying assemblies.

Inserts capable of performing at low flow rates while simultaneously delivering specific geometric patterns across predetermined dimensions can be particularly useful. In one application, a cleansing sprayer capable of wetting the entirety of a hemispheric, rounded surface (like that of a toilet bowl) is particularly challenging, especially when the sprayer can be provided with minimal fluid pressure and comparatively low volumes/fluid usage. Also, performance of conventional fluidic oscillator inserts may be erratic to the point of being non-functional in such compact design parameters (i.e., size of the sprayer head, direction/sweep of the spray area, etc.), as these parameters usually lead to instability in the spray profile, collapse of the spray fan, and poor performance with high viscosity fluids (i.e., fluids, including a surfactant and having a viscosity greater than water) that are normally used in these applications.

Existing products for cleaning toilet bowls also exhibit poor cleaning performance. Known embodiments (as shown in FIG. 1) include a single nozzle with a plurality of dedicated, directionally oriented jets or outlets. These jets tend to deposit dispensed fluids in a set and non-varying pattern. Over time, repeated use of such apparatus leads to a scenario in which only limited surface areas of the toilet bowl come into contact with cleaning fluid, thereby producing unsightly streaks and possibly discolored or stained areas. Insofar as fluidic oscillators can produce a varying and dynamic spray pattern, adoption of such an insert would yield tangible improvements in comparison to these existing products.

Accordingly, it is an object of the present disclosure to provide an effective nozzle/insert, assembly, system, and method for cleaning a surface such as a toilet bowl surface having a 360 degree perimeter or spray pattern reach (i.e., full circumference) that is operable with minimal pressure and reduced volumes of fluid usage (relative to conventional designs). In particular, a compact nozzle that can attain desired spray pattern/performance by relying on fluidic oscillator insert would be welcome.

### SUMMARY OF THE INVENTION

A fluidic oscillator insert is designed to project a full circumference spray pattern (i.e., at least 325° and, more preferably, nearly/up to 360° of projection/coverage) from a single outlet. The insert relies upon a curved radius with a splitter and appropriately sized protrusions, along with curved walls that may even extend along an outer surface of the housing. This arrangement surprisingly produces full circumference, oscillating coverage. Further aspects of the invention include a system and a double exit insert, both of which also produce full circumference oscillating spray patterns with high viscosity fluids.

Further reference should be made to the appended or incorporated information embraced by this disclosure, including any and all claims, drawings, and description. While specific embodiments may be identified, it will be understood that elements from one described aspect may be combined with those from a separately identified aspect. In the same manner, a person of ordinary skill will have the requisite understanding of common processes, components, and methods, and this description is intended to encompass and disclose such common aspects even if they are not expressly identified herein.

### BRIEF DESCRIPTION OF THE DRAWINGS

Operation and further understanding of all the various aspects of this invention may be better understood by reference to the drawings, in which:

FIG. 1 is photograph of a conventional multi-directional sprayer head having jets.

FIGS. 2A and 2B are comparative photographs (relative to FIG. 1) showing various aspects of the invention ejecting an oscillating, full-circumference spray.

FIG. 3 is a top plan schematic view of an exemplary fluidic geometry according to and highlighting certain aspects of the invention.

FIG. 4A is an isometric view of first aspect of the fluidic oscillator insert. FIG. 4B is a central cross sectional view (i.e., taken along an axis L-L bisecting the throat) of FIG. 4A.

FIG. 4C is a top plan view of FIG. 4A. FIG. 4D is an elevated perspective side view of FIG. 4A, while FIG. 4E is a full side view.

FIG. 5A is an isometric view of second aspect of the fluidic oscillator insert. FIG. 5B is a central cross sectional view (i.e., taken along an axis L-L bisecting the throat) of FIG. 5A.

FIG. 5C is a top plan view of FIG. 5A. FIG. 5D is an elevated perspective side view of FIG. 5A, while FIG. 5E is a full side view.

FIGS. 6A and 6B are complimentary, exploded perspective views of the components of a full circumference sprayer system.

FIG. 7A is a perspective view of the system of FIGS. 6A and 6B in its full assembled state, while FIGS. 7B and 7C are complimentary cross sectional views taken along orthogonally drawn centerlines of the feed tube of the system of FIGS. 6A and 6B.

FIG. 8 is a cross sectional side view of the system of FIG. 7A.

FIG. 9 is a top plan, schematic view of a curved housing facilitating full circumference spray according to various aspects disclosed herein.

FIG. 10 is a horizontal cross sectional view of concave housing and double exited insert facilitating full circumference spray according to various aspects disclosed herein. This housing has slots provided at opposing ends and, therefore, requires a double exited insert or two separate inserts.

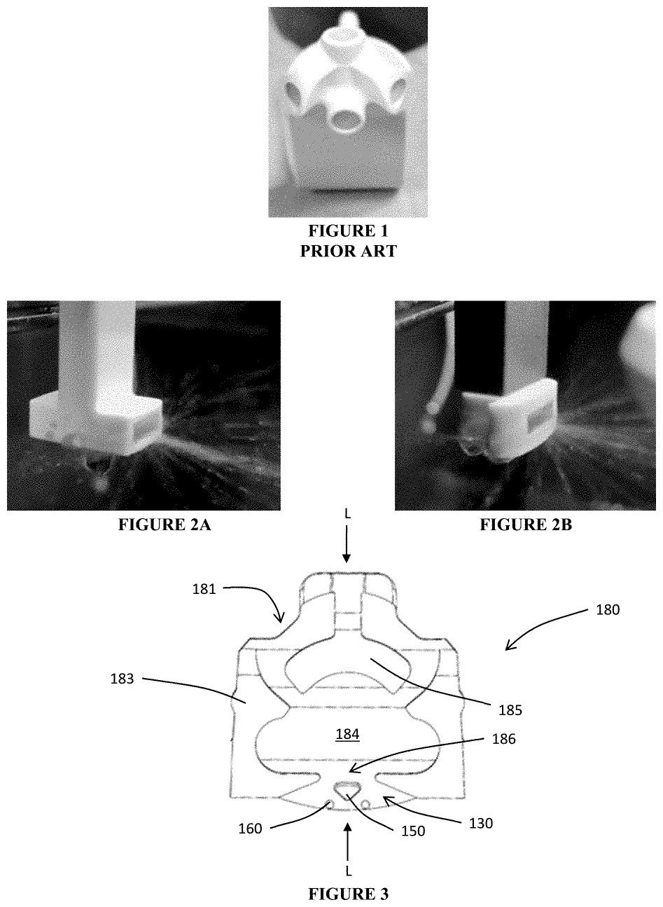

### DETAILED DESCRIPTION

The following description and any reference to the drawings and claims are merely exemplary, and nothing should limit alternatives and modifications that may be possible while adhering to the spirit and scope of the invention. Also, the drawings form part of this specification, and any written information in the drawings should be treated as part of this disclosure. In the same manner, the relative positioning and relationship of the components as shown in these drawings, as well as their function, shape, dimensions, and appearance, may all further inform certain aspects of the invention as if fully rewritten herein.

As used herein, the words “example” and “exemplary” mean an instance or illustration of broader concept; however, use of these words do not necessarily indicate a required, key, or preferred aspect or embodiment. Similarly, the word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise. Approximating language such “about” or “substantially” may be used (or, when consistent with context and reasonable expectations, implied) so as to modify quantitative representations, in which cases the stated value(s)/range(s) may be modified within the reasonable expectations of this art field and not necessarily limited to the precise value specified (unless specifically indicated herein as being precise or critical).

The inventors appreciated that conventional fluidic oscillators tend to be employed in a directional manner. They were unaware of any designs or systems in which a single insert/chip (as well as any systems using two or fewer such chips) could provide full circumference, consistent, and oscillating spray patterns. However, for the reasons noted above, it was understood such items and methods would have particular utility.

Accordingly, various inserts, as well as nozzle assemblies and spraying systems, have been developed. The system relies on a housing with a cavity that retains a fluidic oscillating insert. This insert incorporates a fluidic geometry so that fluid provided to the housing traverse the geometry and is dispensed from an outlet on the fluidic insert. The outlet and, when used, the sidewalls/surfaces surrounding the cavity on the housing are imparted with curving and/or bulbous shapes that distributes the oscillating spray across greater than 180° reach in front of the housing and, more preferably, at least 270°, more preferably at least 325°, and up to 360° relative to a plane defined by the opposing sidewalls defining the outlet on the insert (i.e., full circumference). Alternative embodiments allow for the nozzle assembly to include a front facing outlet and a rear facing outlet, with each insert providing at least 180° coverage. The nozzle assembly may be configured to be a part of a subassembly that includes a platform for resting along a rim of a surface such as a toilet seat to extend within a toilet bowl. The housing may include tubing for receiving fluid therein that can be transferred to the cavity within the housing that contains the fluidic insert. The fluidic geometries should be selected to accommodate low flow rates, with reverse mushroom-shapes being particularly useful (along with the other geometries identified above/herein).

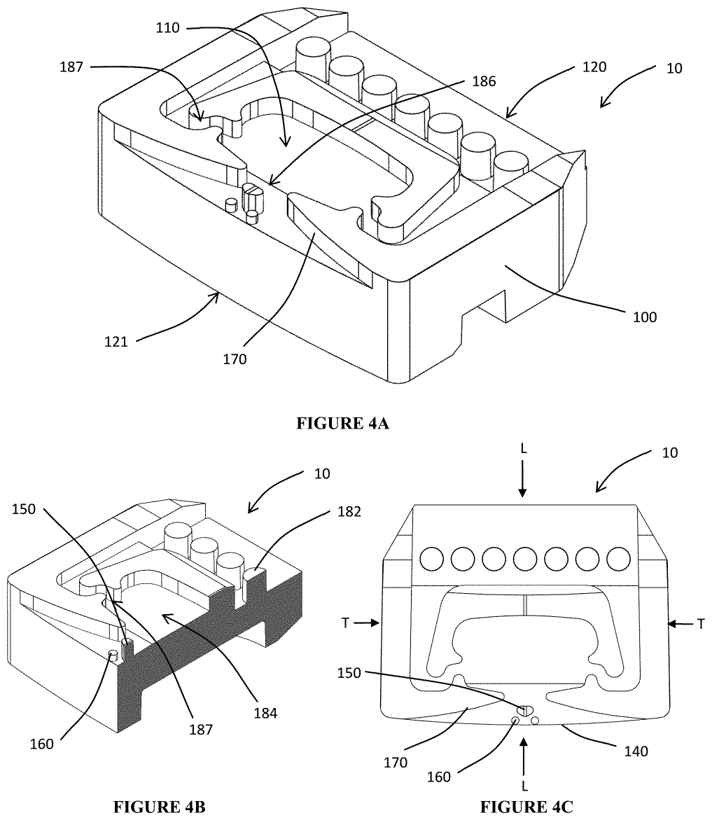

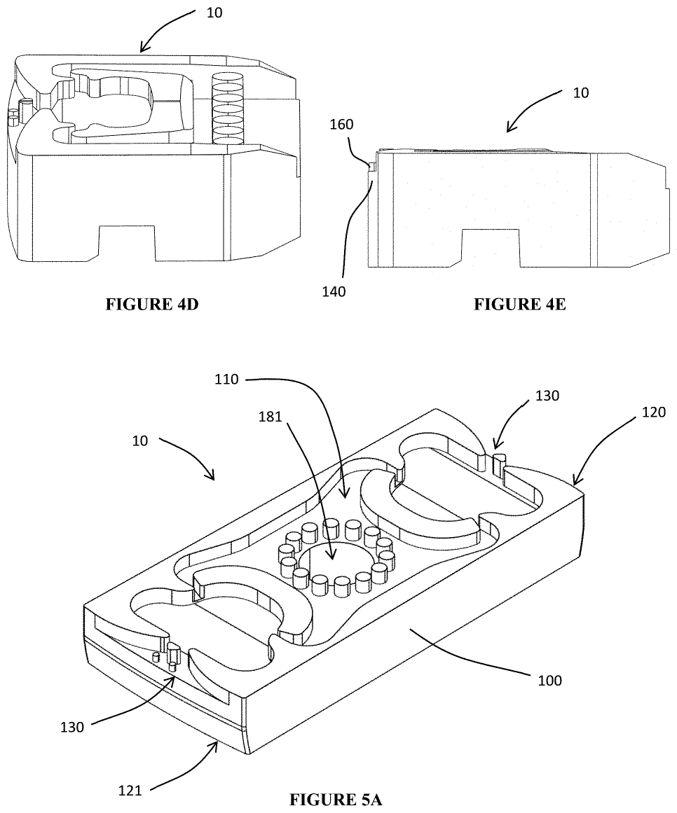

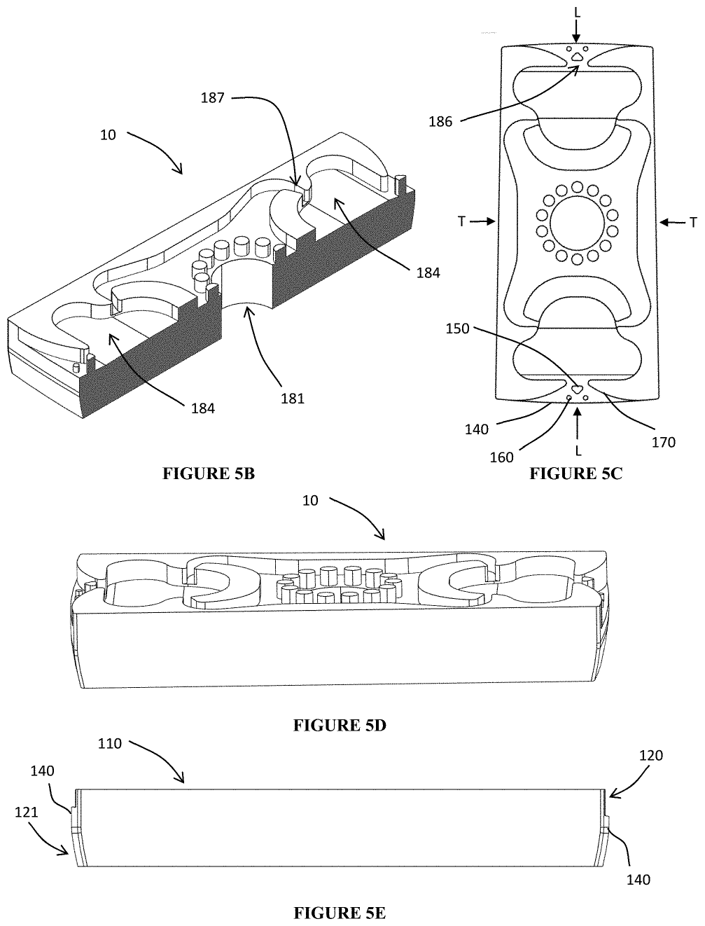

One example of a fluidic geometry is schematically represented in FIG. 3, while FIGS. 4C and 5C provide other specific but non-limiting examples. Generally speaking, fluidic geometery 180 is machined, molded, or manufactured so as to disposed features on at least the top facing 110 of a body 100. In some aspects, one or more of the features can be disposed on the opposite (i.e., bottom facing), with through-holes insuring proper flow. The top facings 110 (and, if used, bottom facings) of the geometry 180 are extend away from the flat planar surface of the body 100, preferably to the same vertical height, so as to sealingly conform to the shape of a cavity within the housing in which the insert 10 is retained.

For purposes of orientation, a longitudinal axis L-L can be drawn along a centerline of the body 100 so as to pass through the outlet 130. Any transverse features (e.g., a midline T-T) will pass orthogonally through this longitudinal axis.

With respect to the features constituting a particular fluidic geometry 180, one or more inlet areas 181 are formed in, on, and/or through an portion of a chip body. The inlet(s) 181 is generally on an opposite transverse side of the body from outlet 130. Raised pins 182 can be provided across and/or around the inlet to prevent unwanted blockages. Raised sidewall portions 183 typically enclose at least the axially-aligned edges, although the transverse edge nearest the inlets 181 may also be enclosed. These sidewalls define an interaction region 184 that is specifically shaped and design to induce specific flow patterns so that, as fluid passes from the inlets 181 to the outlet 130, certain characteristics are achieved (e.g., oscillating patterns, etc.). Islands 185 and/or power nozzle formations 187 can be employed, with the latter (and/or the sidewalls 183) defining the throat 186. The throat 186 is the opening/aperture that allows fluid to flow out of the interaction region 184 and through the outlet 130. At the transverse edge where the outlet 130 is formed, splitter(s) 150, protrusions/speed bumps 160, and straight or curving sidewalls 170 are possibilities (with specific, full-circumference-inducing arrangements described in greater detail below).

Other particular aspects of the geometry 180 that have proven useful to this invention include:
The comparative width of the interaction region (lw) at its largest transverse axis is increased (while a conventional design might have only 7-8 times the size of the power nozzle opening, inventive designs could approach anywhere from 13-14).
The comparative height of the interaction region height (lh) at its largest axial length is increased (while a conventional design might have only 5-6 times the size of the power nozzle opening, inventive designs could approach anywhere 6-7).
The ratio of interaction region dimensions (lw/lh) has a corresponding increase from 1.3 to 1.9.
The axial offset from the bottom end of the power nozzle to the opposing edges defining the throat (i.e., throat offset (To)), is increased from 1.0-1.5 to up to 1.65.
To and Iw have been shown to affect instability (i.e., deviations from/interruptions to the normal frequency of oscillation). This instability can produce increased spray velocity and increased spray uniformity compared to conventional reverse mushroom geometries. By substantially increasing the aspect ratio of the interaction region, the opposing vortices in the interaction region gain an enhanced ability to deflect the exiting jet and the natural fan angle of the reverse mushroom is also increased. These changes enable the present invention to generate a uniform 360 degree spray at flowrate of 100-150 mL/min @ 5 psi.

With further reference to FIGS. 4A through 5E, inserts 10 capable of providing full circumference spray patterns are shown. These inserts 10 are formed in an elongate body 100. The body may have a square or rectangular cube shape to simplify its fit with the housing, although other polygonal or curvilinear forms are possible.

Note that FIGS. 5A through 5E show an insert with a single inlet region 181 feeding two opposing outlets 130, with the features being identical, mirror images relative to a transverse midline T-T of the insert 10. As such, this double-exited insert is designed to project at less than full circumference but greater than 180° out of each throat/outlet. However, it is not necessary to provide the ledges at the same height—that is, the floor defining the ledge 140 can vary on one end 120 as compared to the other end 121.

As above, inserts 10 include an inlet 181 with optional pins 182 oriented in or near end 120 of body 100. The interaction region 184 is defined by the raised sidewalls 183, and an island 185, throat 186, and power nozzles 187 are preferred features for this fluidic geometry, all of which are positioned on opposing end 121 of the body 100.

However, the inventors have found the most critical features to delivering the desired, full circumference spray relate to the features of the outlet 130 (formed in end 121). In particular, a curved ledge 140 includes a splitter 150, speed bumps/protrusions 160, and sidewalls 170. This specific combination of features helps to insure oscillating fluid flow out of the throat is appropriately shaped to deliver a wide/full circumference spray within a transverse plane of the body 100.

The splitter 150 and the comparatively smaller shaped speed bumps 160 are positioned in front and aligned along a common axis with the transition of throat-to-outlet. The curved outlet sidewalls 170 extend outwardly and should be aligned with the splitter and both speed bumps. This configuration provides a unique improvement that generates a wider spray fan than previously thought possible. As the name “speed bump” implies, the cylindrical features are employed to slow down the oscillating jet without fully obstructing the jet. Previously, this decreased velocity was incurred simply to benefit spray uniformity, but it was not deemed useful to increasing fan angle so that conventional splitters were sized and positioned to break up heavy bands of fluid within the spray fan so as to make the overall mass distribution of the spray became more uniform (i.e. sacrificing spray radius/to improve the precipitation rate and/or scheduling coefficient).

The ledge 140 is unique in comparison to most conventional fluidic inserts because it possesses a convex or outwardly curved section. This curved section has a radius that is centered along the axis L-L and, in some cases the midpoint of the throat 186. Notably, the curved section at least runs between the sidewalls 170 that help define the outlet 130, although this curve may be carried across the entire transverse edge. Notably, this curve will fit substantially flush within the exterior facing of the housing of a spray assembly so as to present a smooth and continuous curved surface, as will be described below.

Splitter 150 is elevated to the same height as sidewalls 183 (i.e., it should present as a total vertical obstruction within the outlet immediately downstream of the throat). Preferably, it has a generally triangular in shape, with a top sidewall 151 generally parallel to the throat and the other two sidewalls converging in a point 152 that is preferable located on the axis L-L. Any one or all of these pointed edges may be rounded or bulbous. Other shapes may also be employed.

Protrusions or speed bumps 160 do not completely obstruct the outlet. In some aspects, the speed bumps 160 only extend upward to occupy one half or less of the height of the outlet 130 (i.e., the height of the splitter 150, which necessarily forms a sealing surface, the same as the sidewalls 183 and other selected elements of the fluidic geometry 180), and they should have a round (circular or oval) shape. Two speed bumps 160 are preferred, with their positions being mirror-images both axially and transversely, relative to the splitter 150 (and, more specifically, point 152).

The speed bumps 160 not only improve uniformity, but also deflect the oscillating jet to increase fan angle. In particular, conventional speed bumps typically occupied ≤7% of the cross-sectional area of the throat orifice (TA) as defined by the axially aligned portions of the throat (i.e., the corner of the interaction region 184 on one end and the beginning of the sidewalls 170 on the other), the preferred embodiment speed bumps occupy larger areas, up to 15-30% of TA. They are also positioned much closer to throat width (Tw) (0.6× versus 1.2× for conventional designs), which is defined as the transverse axis of the throat at the point where the sidewalls 170 begin diverging away from this bottom end of the throat 186). The resultant speed bumps are more effective at deflecting the jet towards the curved front surface of the nozzle and have been proven vital to generating the desired spray performance.

The sidewalls 170 preferably form mirror images. They may be straight or curved outwardly so as to insure the transverse axis between each sidewall in the outlet 130/ledge 140 will always increase as the jet approaches the very end of the ledge 140.

Advantages and unique characteristics of the various aspects of the insert and system, as well as the underlying methods of providing a full circumference oscillating spray embraced by these aspects, include:
A fluidic insert whose geometry (such as mushroom or reverse mushroom circuits, along with other conventional arrangements referenced herein) produces a fairly wide natural fan angle.
The specific design of the circuit geometry shown herein that has proportionally matched dimensions of its interaction region width, height, and throat offset. Also, the orientation and geometric location/relationship of the splitter and the protrusions (i.e., “speed bumps”) relative to the throat of the base circuit.
A housing that continues the curvature of the front face of the insert, or in an alternate embodiment having an increasing curvature, to maintain good jet attachment and resultant breakup. As a result, the system presents a substantially smooth front face in which the insert matches the smooth curvature surface of the housing so as to produce a strong, evenly distributed spray pattern. In this regard, the specific tolerances for insert depth within the housing will impact the resulting spray patterns.

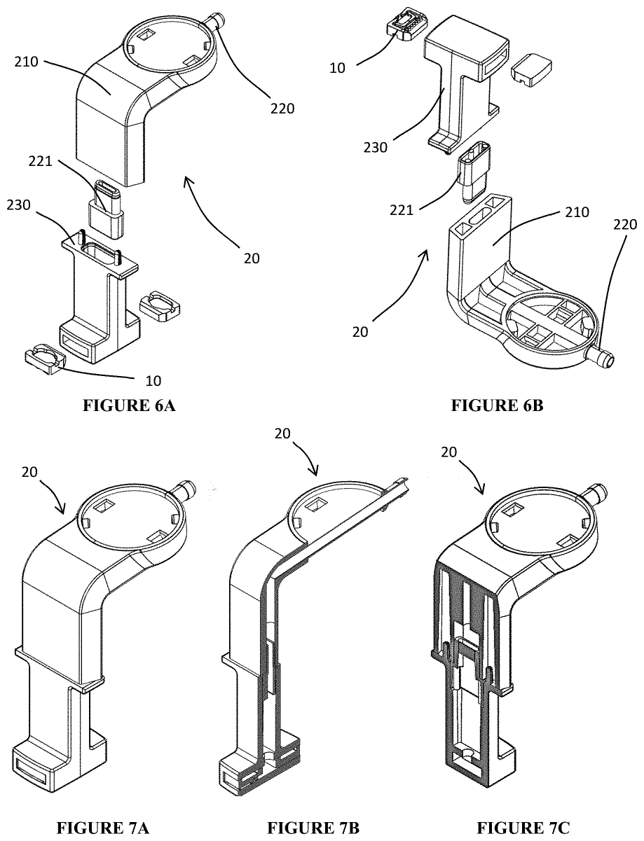

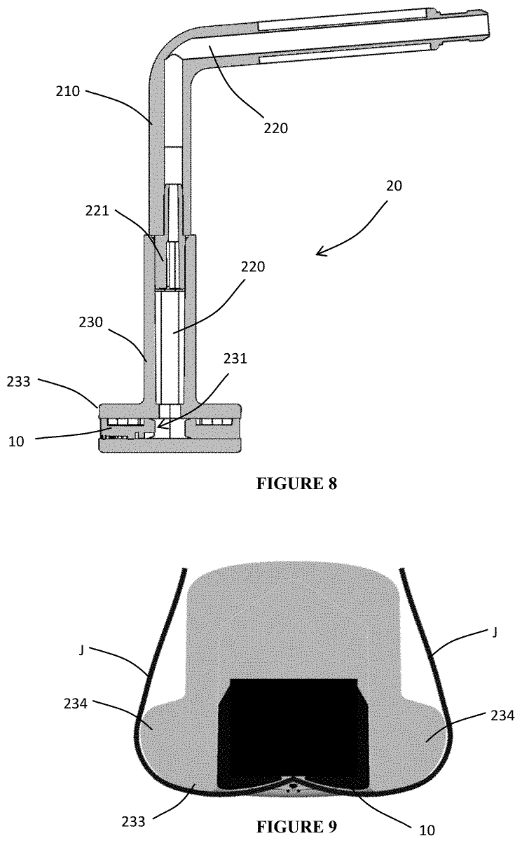

Additionally, and with further reference to FIGS. 6A through 10, a system 200 is contemplated. It includes a connector 210 body having a bent shape, preferable resembling an L- or J-shape so as to position the connection of delivery tube 220 to a fluid source in or on the toilet tank, while the housing 230 is positioned beneath the toilet bowl rim. In this manner, the insert(s) in the housing will spray the rounded portions of the bowl without dispensing and wasting fluid on or above the rim. An intermediate connector 221 may be employed to secure the elements 210, 230 and/or to improve or transition the flow from tube 220 to the inlet(s) 181.

The fluid fed into the tube 220 can be any commercially available cleaning solution. Best spray patterns will be achieved by a fluid that has a higher viscosity than the tap water provided to the toilet tank, although water and aqueous solutions of similar viscosity can be used. This fluid might include one or more sanitizers (e.g., bleach), thickening agents, and/or one or more surfactants. The fluid may also be drawn directly from the toilet tank itself.

The housing 230 will include a slot 231 sized and shaped to receive and seal the insert 10. Opposing slots can be provided to accommodate two separate inserts, or the slot may form a tunnel through the housing to receive a double-exit insert.

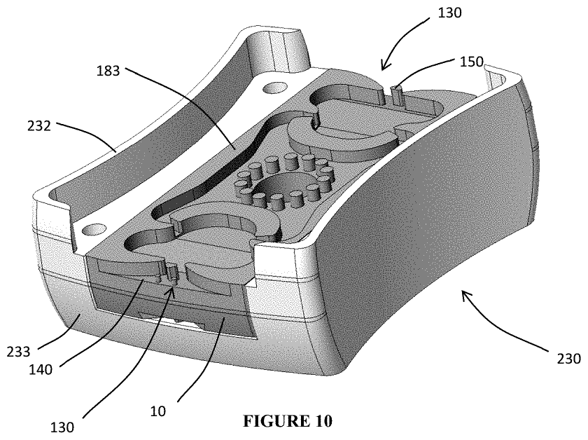

The sidewalls 232 may be straight (as shown in FIG. 7A), concave (as shown in FIG. 10), or provided with a bulbous section 234 (as shown in FIG. 9). Bulbous section 234 will facilitate further redirection of the jet J exiting the outlet so as to enhance and insure full circumference spraying. In contrast even though the housing 230 has convex sidewalls 232 in FIG. 10, the double exit (or two separate single exit) insert 10 retains the features of the embodiments above (e.g., splitter, speed bumps, curved/radius ledge) so as to insure each outlet 130 covers at least 180° in order to deliver full-circumference spray patterns.

In all of these embodiments, the slot 231 will be formed in a curved facing 233 of the housing 230. This curve may run from vertical edge to vertical edge and/or from top-to-bottom edge. In all instances, the outlet 130 of the insert 10 will be flush so as to present a smooth transition with the facing 233. This forms a fluidic seal and the housing slot edges maintain the jet (rather than breaking it off, as in conventional designs). Thus, attachment and the tolerance of the edge sharpness and insert installation depth (proud, flush, or sub-flush) affect the resultant spray fan angle and distribution, and even relatively small mismatches in the front surfaces and edge radii of the insert and housing cause the spray to separate from the front surface prematurely, resulting in reduced spray fan angle and uniformity. Also, as the nozzle operating pressure is increased, the flowrate and the spray velocity also increase and the lower the viscous/surface tension/Coand\check{a} forces are, relative to the inertial forces of the jet. Thus, at some sufficiently large critical pressure, the jet will separate from the front surface, causing the effective fan angle of the nozzle will degrade. So as the intended operating pressure increases, it is desirable that the front surface is smooth and free of steps/defects/etc.

In view of the foregoing, one aspect of the invention includes a fluidic oscillator insert with a polygonal body having a fluidic geometry embedded on at least a top facing of the body. This fluidic geometry include an interaction chamber with a throat feeding fluid into an outlet, and the outlet is aligned along a longitudinal axis of the body and defined on each side by first and second sidewalls extending from opposing edges of the throat to a convex protruding ledge, with the ledge conforming to a radial curve centered about the throat. A splitter obstruction is positioned on or over the longitudinal axis and in between the first and second sidewalls that define the outlet (i.e., downstream from the throat), while a pair of protrusions extend upwardly from the top facing at a height that is less than a corresponding height of the splitter, and with each protrusion positioned on opposing sides of the longitudinal axis. Additionally, the insert could include anyone or combination of the following features:
wherein the first and second sidewalls are symmetrical;
wherein the first and second sidewalls curve outwardly;
wherein the splitter has a triangular shape;
wherein the protrusions are identically shaped and spaced apart from the ledge;
wherein the protrusions are circular and extend upwardly away from the top facing at a height that is less than one half of a corresponding height for the splitter;
wherein the insert includes two mirror-image fluidic geometries positioned around a middle line extending orthogonally from the longitudinal axis, each of the mirror image fluidic geometries having outlets on opposing edges the body and corresponding convex ledges, splitters, and protrusions;
wherein the longitudinal axis bisects the body so as to divide it into equally sized transverse half sections; and
wherein the transverse half sections are mirror-images relative to the longitudinal axis.

Another aspect of the invention contemplates a full circumference, oscillating spray system including a connector carrying a fluid delivery tube and a housing coupled to the connector with a slot. Any of the fluidic oscillator inserts identified above can be positioned within the slot so as to establish fluid communication between the fluid delivery tube, the interaction chamber, and the outlet. Additionally, the sidewalls of the outlet in the insert curve outwardly in a manner that extends along onto corresponding curved outer surfaces of the housing on opposing edges of the slot and/or the corresponding curved outer surfaces on the body define bulbous edges so that fluid is guided along the bulbous edge to project a full circumference spray pattern.

All components of the pump dispenser should be made of materials having sufficient flexibility and structural integrity, as well as a chemically inert nature. The materials should also be selected for workability, cost, and weight. Common polymers amenable to injection molding, extrusion, or other common forming processes may have particular utility, the same as various metals, alloys, and additive manufacturing materials.

References to coupling in this disclosure are to be understood as encompassing any of the conventional means used in this field. This may take the form of snap- or force fitting of components, although threaded connections, bead-and-groove, and slot-and-flange assemblies could be employed. Adhesive and fasteners could also be used, although such components must be judiciously selected so as to retain the intended functionality of the assembly.

In the same manner, engagement may involve coupling or an abutting relationship. These terms, as well as any implicit or explicit reference to attachment of parts, should be considered in the context in which it is used, and any perceived ambiguity can potentially be resolved by referring to the drawings.

Although the disclosure has been described with reference to specific embodiments detailed herein, other embodiments can achieve the same or similar results. Certain variations and modifications of the disclosure can be undertaken by those skilled in the art at the time this invention was made, and this disclosure and claims are intended to cover any and all such modifications and equivalents to the maximum extent permitted by applicable law.

1. A fluidic oscillator insert comprising:
a body having a fluidic geometry embedded on at least a top facing of the body, the fluidic geometry including an interaction chamber with a throat feeding fluid into an outlet;
wherein the outlet is aligned along a longitudinal axis of the body and defined on each side by first and second sidewalls extending from opposing edges of the throat to a convex protruding ledge, with the ledge conforming to a radial curve centered about the throat;
wherein a splitter is positioned about the longitudinal axis and in between the first and second sidewalls; and
wherein a pair of protrusions extend upwardly from the top facing at a height that is less than a corresponding height of the splitter, each of the protrusions is positioned on opposing sides of the longitudinal axis.

2. The insert of claim 1 wherein the first and second sidewalls are symmetrical.

3. The insert of claim 1 wherein the first and second sidewalls curve outwardly.

4. The insert of claim 1 wherein the splitter has a triangular shape.

5. The insert of claim 1 wherein the protrusions are identically shaped and spaced apart from the ledge.

6. The insert of claim 1 wherein the protrusions are circular and extend upwardly away from the top facing at a height that is less than one half of a corresponding height for the splitter.

7. The insert of claim 1 wherein the insert includes two mirror-image fluidic geometries positioned around a middle line extending orthogonally from the longitudinal axis, each of the mirror image fluidic geometries having outlets on opposing edges the body and corresponding convex ledges, splitters, and protrusions.

8. The insert of claim 1 wherein the longitudinal axis bisects the body so as to divide it into equally sized transverse half sections.

9. The insert of claim 8 wherein the transverse half sections are mirror-images relative to the longitudinal axis.

10. A full circumference, oscillating spray dispensing system comprising:
a connector carrying a fluid delivery tube;
a housing coupled to the connector with a slot; and
the fluidic oscillator insert of claim 1 positioned within the slot so as to establish fluid communication between the fluid delivery tube, the interaction chamber, and the outlet.

11. The system of claim 10 wherein the sidewalls of the outlet in the insert curve outwardly in a manner that extends along onto corresponding curved outer surfaces of the housing on opposing edges of the slot

12. The system of claim 11 wherein the corresponding curved outer surfaces on the body define bulbous edges so that fluid is guided along the bulbous edge to project a full circumference spray pattern

13. A compact, full circumference oscillating spray dispensing system comprising:
a connector carrying a fluid delivery tube;
a housing coupled to the connector with an aperture extending orthogonal to the fluid delivery tube through opposing facings of the housing; and
the fluidic oscillator insert of claim 7 positioned within the slot so as to establish fluid communication between the fluid delivery tube, the interaction chamber, and each of the mirror image outlets at the opposing facings of the housing.
